(19) United States
(12) Patent Application Publication
(10) Pub. No.: US 2020/0004901 A1
(43) Pub. Date: Jan. 2, 2020

(54) Systems and Methods for Modeling Symmetry Planes and Principal Orientation from 3D Segments

(71) Applicant: Geomni, Inc., Jersey City, NJ (US)

(72) Inventor: Jose Luis Esteban, Madrid (ES)

(73) Assignee: Geomni, Inc., Jersey City, NJ (US)

(21) Appl. No.: 16/458,763

(22) Filed: Jul. 1, 2019

Related U.S. Application Data
(60) Provisional application No. 62/691,755, filed on Jun. 29, 2018.

(51) Int. Cl. G06F 17/50; G06T 17/10; G06K 9/52; G06T 7/68; G06T 7/73

(52) U.S. Cl. CPC G06F 17/5004; G06T 17/10; G06T 7/73; G06T 7/68; G06K 9/52

(57) ABSTRACT

A system and method for automatically modeling symmetry planes and principal orientations from three dimensional (“3D”) segments. The system comprises receiving a set of 3D segments representing a structure from the input source, wherein the set of 3D segments comprises one or more segment pairs. The system then generates symmetry plane data by calculating a symmetry plane for each of the one or more segment pairs. Next, the system accumulates the symmetry plane data in a Hough space. Lastly, the system constructs one or more Hough space symmetry planes from the symmetry plane data and calculates a principal orientation of the structure.

### RELATED APPLICATION

This application is a continuation application of and claims priority to U.S. Provisional Patent Application No. 62/691,755 filed on Jun. 29, 2018, the entire disclosure of which is expressly incorporated herein by reference.

### BACKGROUND

### Technical Field

The present disclosure relates generally to the field of computer modeling of structures. More specifically, the present disclosure relates to computer systems and methods for modeling symmetry planes and principal orientations from 3D segments.

### Related Art

Accurate and rapid identification and depiction of objects from digital images (e.g., aerial images, satellite images, ground-based images, etc.) is increasingly important for a variety of applications. For example, information related to the roofs of buildings is often used by construction professionals to specify materials and associated costs for both newly-constructed buildings, as well as for replacing and upgrading existing structures. Further, in the insurance industry, accurate information about structures can be used to determining the proper costs for insuring buildings/structures. Still further, government entities can use information about the known objects in a specified area for planning projects such as zoning, construction, parks and recreation, housing projects, etc.

Various software systems have been implemented to process aerial images to identify a set of 2D segments and generate a 3D model of a structure. The detection of line segments on 2D images is a robust procedure that can be performed using various techniques. In addition, a collection of detected segments is more manageable than a collection of points because of the smaller number of elements.

Man-made structures, such as rooftops, are normally characterized by the presence of symmetries. The existence of such symmetries reduces the complexity of the 3D model. By reducing the complexity of a 3D model, a system can generate a 3D model at a faster rate, require less memory to store the 3D model, and require less data to produce the 3D model. This would improve the function and capabilities of the system. As such, the ability to detect symmetries is a powerful tool during the induction of a 3D structure. Accordingly, the computer systems and methods disclosed herein solve these and other needs by providing robust detection of vertical symmetry planes in 3D segment clouds and also deriving a principal orientations of an overall segment cloud.

### SUMMARY

This present disclosure relates to computer systems and methods for modeling symmetry planes and principal orientations from 3D segments. The 3D segments can correspond to roofs, sidewalks, building structures, pools edges, concrete flatwork, property structural features (structures, buildings, pergolas, gazebos, terraces, retaining walls, and fences), sports courts, and other structures. The 3D segments can be stored in 3D segment clouds. The system processes multiple pairs of the 3D segments from the 3D segment cloud, and determines a symmetry plane between each segment pair. The system can then accumulate data from the symmetry planes and input the data into a Hough space. The system can then construct the symmetry planes in the Hough space based on the symmetry plane data.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart illustrating overall process steps carried out by the system of the present disclosure;

FIG. 2 is a diagram illustrating a 3D segment pair and a symmetry plane for the segment pair;

FIG. 3 is a flowchart illustrating step 12 of FIG. 1 in greater detail;

FIGS. 4A-4B are diagrams illustrating a 3D segment pair and a symmetry plane for the segment pair;

FIGS. 5A-5B are diagrams illustrating a 3D segment pair and a symmetry plane for the segment pair;

FIG. 6 is a flowchart illustrating the process steps carried out by the system for determining a weight of a symmetry plane;

FIG. 7 is a flowchart illustrating step 14 of FIG. 1 in greater detail;

FIG. 8 is a diagram illustrating the Hough space parameters for a vertical plane;

FIG. 9 is a flowchart illustrating step 16 of FIG. 1 in greater detail;

FIGS. 10A-10B are diagrams illustrating examples of a Hough accumulator; and

FIG. 11 is a diagram illustrating sample hardware components on which the system of the present disclosure could be implemented.

### DETAILED DESCRIPTION

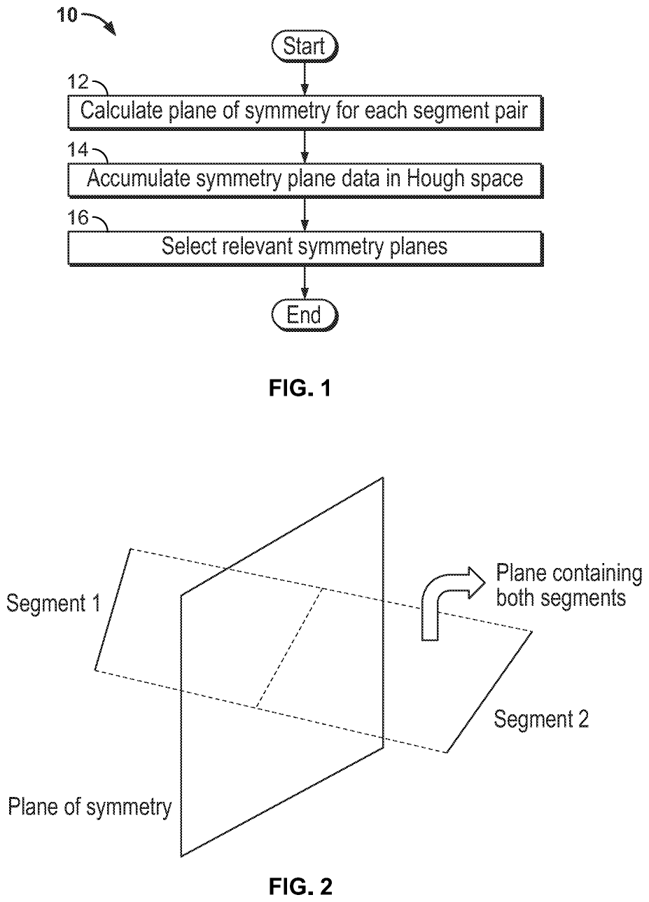

The present disclosure relates to computer systems and methods for modeling symmetry planes and principal orientations from 3D segments, as described in detail below in connection with FIGS. 1-11.

It should first be noted that the system of the present disclosure processes a set of three dimensional (“3D”) segments as an input. The set of segments discussed in this disclosure is related to a set of line segments in a 3D segment cloud. Also disclosed herein are methods for determining vertical symmetry planes between multiple pairs of the 3D segments along with a main and secondary orientations of the 3D segment cloud.

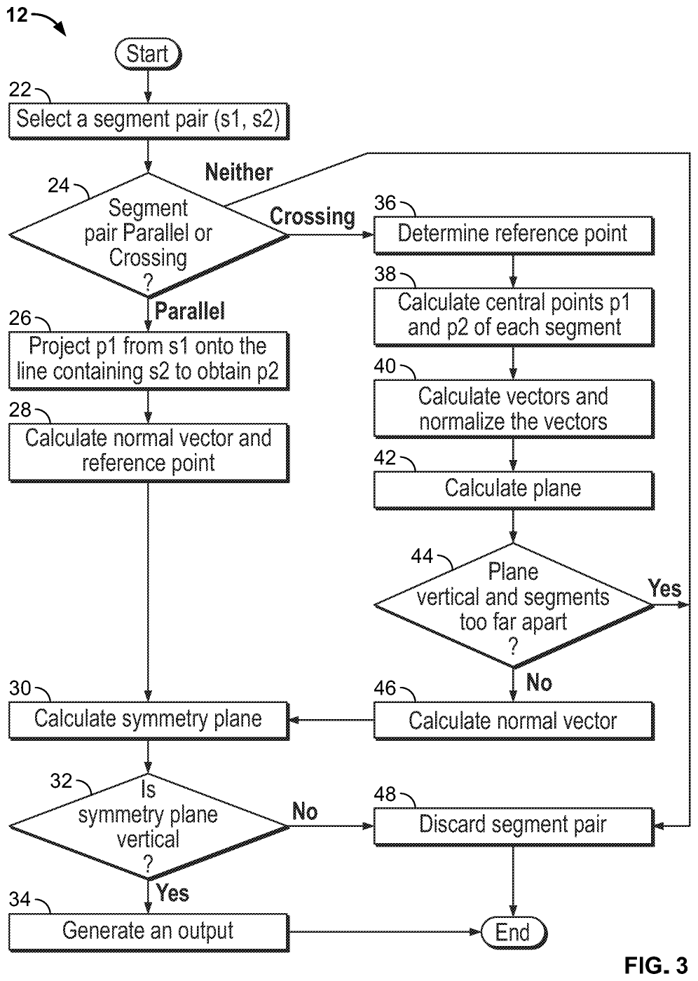

FIG. 1 is a flowchart illustrating overall process steps carried out by the system, indicated generally at 10. In step 12, the system calculates a plane of symmetry (symmetry plane) for a segment pair in the segment cloud. This step can be performed for every segment pair in the segment cloud or for a number of segment pairs in the segment cloud. In an example, non-vertical planes are not relevant and are discarded, as will be discussed in more detail in FIG. 3. In step 14, the system accumulates symmetry plane data in a Hough space. In step 16, the system selects relevant symmetry planes. Steps 12-16 will be discussed in more detail below.

FIG. 2 illustrates a diagram of a segment pair and a symmetry plane for the segment pair. The processing steps discussed in connection with FIG. 1 allow the system to identify the plane of symmetry given the segments 1 and 2 shown in FIG. 2.

The process steps of the invention disclosed herein could be embodied as computer-readable software code executed by one or more computer systems, and could be programmed using any suitable programming languages including, but not limited to, C, C++, C#, Java, Python or any other suitable language. Additionally, the computer system(s) on which the present disclosure can be embodied includes, but is not limited to, one or more personal computers, servers, mobile devices, cloud-based computing platforms, etc., each having one or more suitably powerful microprocessors, graphical processing units (“GPUs”) and associated operating system(s) such as Linux, UNIX, Microsoft Windows, MacOS, etc. Still further, the invention could be embodied as a customized hardware component such as a field-programmable gate array (“FPGA”), application-specific integrated circuit (“ASIC”), embedded system, or other customized hardware component without departing from the spirit or scope of the present disclosure.

FIG. 3 is a flowchart illustrating step 12 of FIG. 1 in greater detail. In particular, FIG. 3 illustrates process steps for calculating a symmetry plane for a segment pair in the segment cloud. In step 22, the system selects a segment pair (s1, s2). Each segment of the segment pair can be from a different image. For example, the first line segment (s1) can be inputted into the segment cloud from a first image and the second line segment (s2) can be inputted into the segment cloud from a second image.

In step 24, the system determines whether the segment pair is a parallel pair, a crossing pair, or neither. The system determines that the segment pair is a parallel pair when a direction vector of the first line segment and the second line segment are equal to or opposite from each other within a predetermined tolerance value. The system determines that the segment pair is a crossing pair when a projection line of the first line segment and the second line segment cross paths at a point on a plane containing both segments, or when a crossing point of best approximation is less than a predetermined tolerance value. If the segment pair is neither a parallel pair nor a crossing pair, this can indicate that the first line segment and the second line segment do not lie on the same plane. Thus, when the segment pair is neither a parallel pair nor a crossing pair, the system proceeds to step 48, where the segment pair is discarded.

When the segment pair is a parallel pair, the system proceeds to step 26. In step 26, the system projects a first point (p1) from the first line segment onto a line that contains the second line segment, to obtain a second point (p2). Next, in step 28, the system calculates a normal vector (n) and a reference point (p). The normal vector can be calculated using the formula: n=p2−p1. The reference point, which can be an intermediary point, can be calculated using the formula: p=(p1+p2)/2.

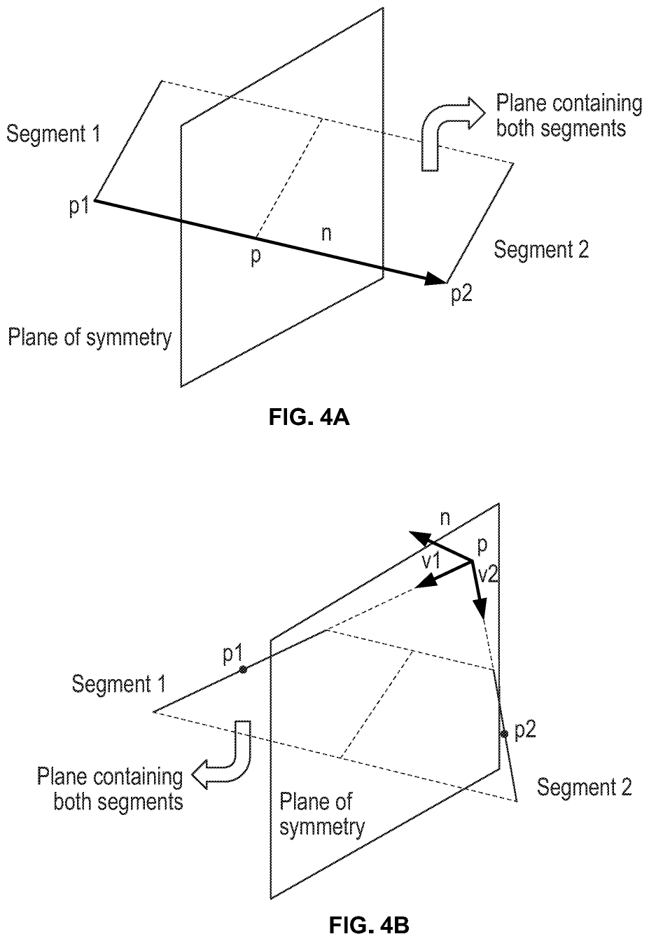

In step 30, the system constructs a symmetry plane between the first line segment and the second line segment. The symmetry plane is constructed using the reference point and the normal vector. In step 32, the system determines whether the symmetry plane is vertical within a predetermined tolerance value. When the symmetry plane is not vertical within the predetermined tolerance value, the system proceeds to step 48, where the segment pair is discarded. When the symmetry plane is vertical within the predetermined tolerance, the system proceeds to step 34. In step 34, the system generates an output (“referred to as a triple”), which contains the first line segment, the second line segment, and the symmetry plane. FIG. 4A is a diagram illustrating the parallel segment pair and the symmetry plane of the segment pair, as well as the points p, p1, and p2 and the normal n calculated by the system as discussed above in connection with FIG. 3.

Returning to step 24 (FIG. 3), when the segment pair is a crossing pair, the system proceeds to step 36. In step 36, the system determines a reference point (p) by determining a crossing point of a first line containing the first line segment and a second line containing the second line segment. The reference point r can be an approximation within predetermined tolerance value.

In step 38, the system calculates a first central point (pl) of the first line segment and a second central point (p2) of the second line segment. It should be noted that central points are used because the central points are more robust than end points of the segment pair. However, in an example, end points or other points of the segment pair can be used. In step 40, the system calculates a first vector (v1) from the reference point to the first central point and a second vector (v2) from the reference point to the second central point. The system then normalizes the first vector and the second vector. In step 42, the system calculates a plane containing the reference point, the first vector and the second vector.

In step 44, the system determines whether the plane is vertical within a predetermined tolerance value and whether the first line segment and the second line segment are too far apart from each other. For example, the system can determine whether a distance between the first segment and the second segment is greater than a predetermined threshold value. When the plane is vertical and the first line segment and the second line segment are determined to be too far apart from each other, the system proceeds to step 48, where the segment pair is discarded. When the symmetry plane is vertical and the first line segment and the second line segment are determined to be not too far apart from each other, the system proceeds to step 46. In step 46, the system calculates a normal vector (n). The normal vector can be calculated using the formula: n=v2−v1.

The system then proceeds to step 30 and calculates the symmetry plane between the first line segment and the second line segment. The symmetry plane is calculated using the reference point and the normal vector. In step 32, as discussed above, the system determines whether the symmetry plane is vertical within the predetermined tolerance value. When the symmetry plane is not vertical within the predetermined tolerance value, the system proceeds to step 48, where the segment pair is discarded. When the symmetry plane is vertical within the predetermined tolerance, the system proceeds to step 34. In step 34, the system outputs the triple, which comprises the first line segment, the second line segment, and the symmetry plane. FIG. 4B is a diagram illustrating the diagram of a parallel segment pair and the symmetry plane of the segment pair, including the center points p1 and p2, the point p, and the vectors n, v1, and v2 calculated by the system as discussed above in connection with FIG. 3.

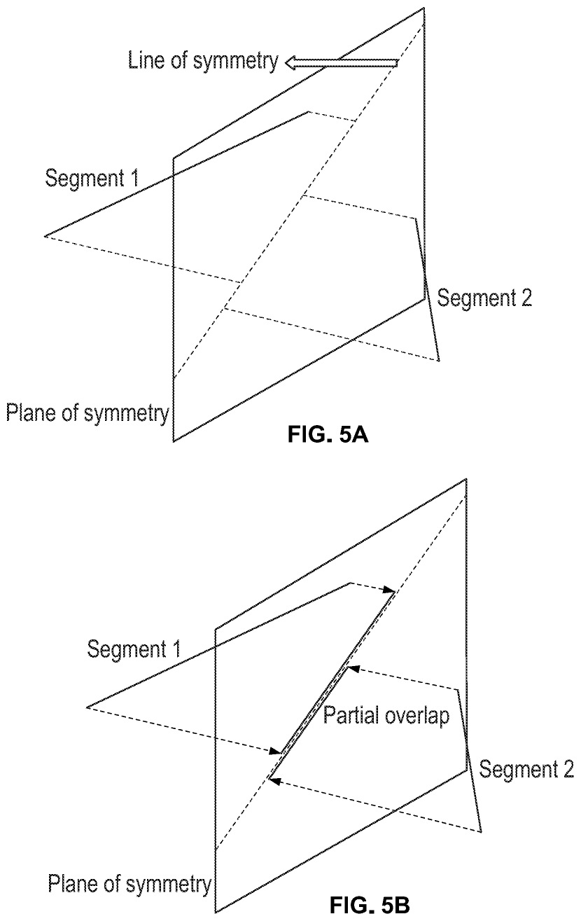

The first line segment and the second line segment may not align and/or be of the same length, as illustrated in FIG. 5A. It should first be noted that a perfectly aligned segment pair should have more impact than a marginally aligned segment pair. As such, each symmetry plane includes a weight based on a predetermined criteria. In a first example, the criteria can include assigning a higher weight to a symmetry plane with longer line segments. In a second example (as illustrated in FIG. 5B), the criteria can include assigning a higher weight to a symmetry plane with a higher degree of overlap between a first line segment and a second line segment.

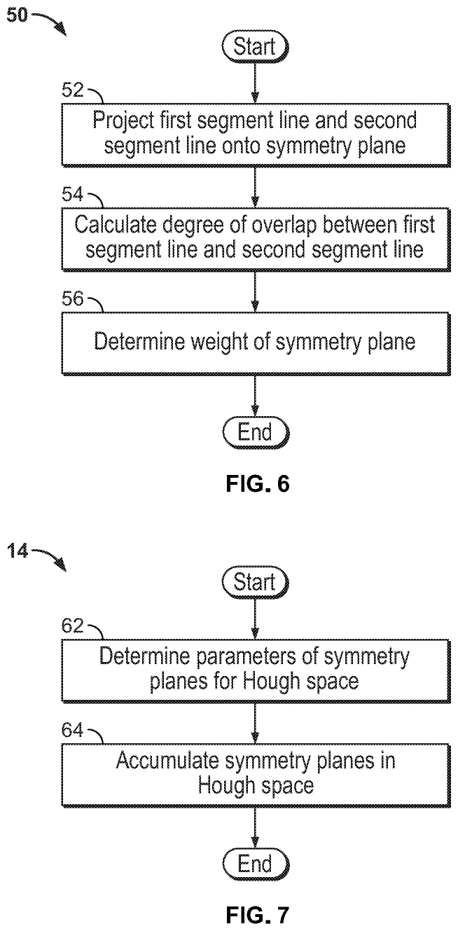

FIG. 6 is a flowchart illustrating process steps carried out to determine a weight of the symmetry plane, indicated at 50. In step 52, the system projects the first line segment and the second line segment onto their symmetry plane. In step 54, the system calculates a degree of overlap (d) between the first line segment and the second line segment. The degree of overlap can be calculated as a length of the overlapping region divided by the length of a smaller projected segment of the segment pair. The degree of overlap will yield a value between 0 and 1. In step 56, the system determines a weight (w) of the symmetry plane. In an example, the weight can be calculated as the product of the degree of overlap and a length of the shortest, unprojected line segment.

It should be noted that each of the segments lines can be checked against each other to determine whether each pair of segments lines produce a vertical symmetry plane. As such, a total of n*(n−1)/2 segment pairs will be checked, where n is a total number of line segments. Each vertical symmetry plane that is produced by a segment pair can be accumulated into a Hough space. Non-vertical planes can be discarded.

FIG. 7 shows a flowchart illustrating step 14 of FIG. 1 in greater detail. In particular, FIG. 7 illustrates process steps for accumulating symmetry plane data into a Hough space. In step 62, the system determines parameters of the symmetry planes for the Hough space. It should first be noted that because the symmetry planes accumulated into the Hough space are vertical, the parameters of the symmetry planes can be calculated by regarding the symmetry planes as lines (e.g., such as when viewing a vertical plane from the top). Each line can be the result of an intersection with each symmetry plane and a horizontal plane. The horizontal plane can be established as z=0. An arbitrary reference point (r) for all symmetry planes can also be set at z=0. In an example, the reference point r should be near a center of the segment cloud. It should further be noted that the Hough space can be made up of cells (e.g., a grid).

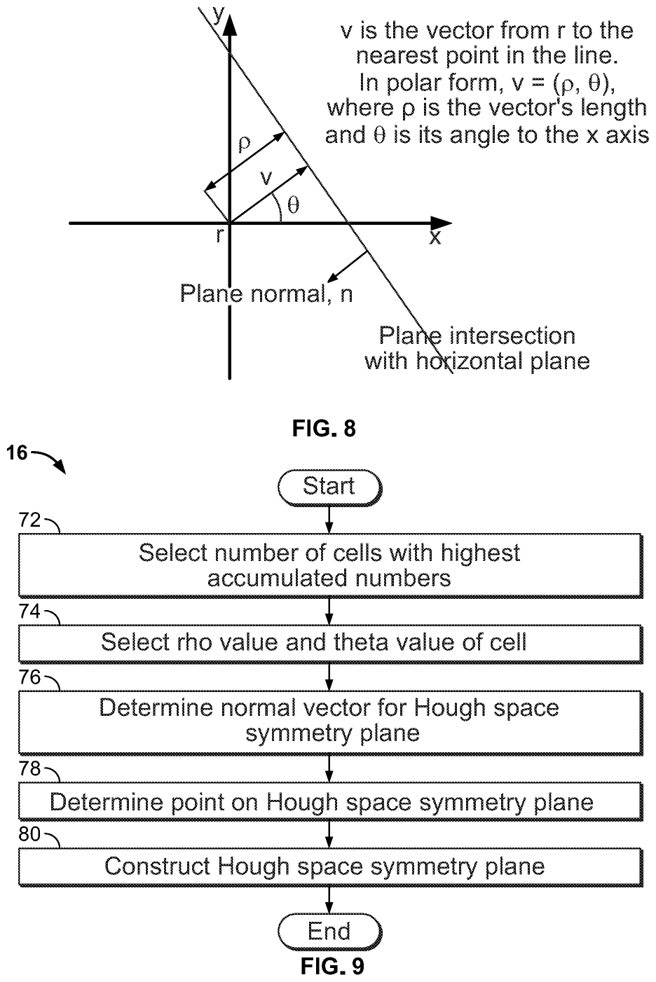

Continuing with step 62, the system calculates a line parameter rho (ρ) and a line parameter theta (θ) for each symmetry plane. First, the system converts a symmetry plane into a line by intersecting the symmetry plane with the horizontal plane at z=0. Next, the system calculates a vector (v) from the reference point (r) to the nearest point on the line. FIG. 8 illustrates an example of determining the Hough space parameters for the symmetry plane.

In an example, the line parameter theta can be set as the smallest angle between the vector (v) and the x axis. The line parameter rho can be set as the distance from the line to the reference point (r). In another example, where the symmetry plane either crosses or is near the reference point, the line parameter theta can be set as the smallest angle between the normal vector of the symmetry plane and the line parameter rho can be set to a value of zero.

In step 64, the system accumulates the symmetry planes in the Hough space. The Hough space can be defined in two dimensions by using the line parameter rho and the line parameter theta. Further, each cell of the Hough space can be a real number accumulator that is associated with a line parameter rho value and a line parameter theta value. The cell that best represents the parameters rho and theta in the accumulator is selected and the plane's weight is added to the selected cell.

The line parameter rho values can have a range from zero to a maximum distance from the reference point to a point in the cloud segment. The line parameter theta values can have a range from −π to π. Values for the line parameter rho and the line parameter theta can be increments of a predetermined number of equal intervals within the range of the line parameter rho and the line parameter theta. For example, the range of theta can include 100 equal intervals between −π to π. Those skilled in the art would understand that the amount of intervals can be equal or unequal and can be any number for both, the line parameter theta values and the line parameter rho values.

FIG. 9 shows a flowchart illustrating step 16 of FIG. 1 in greater detail. In particular, FIG. 9 illustrates process steps for selecting relevant symmetry planes. After all of the segment pairs are processed and accumulated into the Hough space, in step 72, the system selects a number of cells with the highest accumulated numbers. Each selected cell represents a symmetry plane. The respective parameters of the symmetry plane can be used to calculate a Hough space symmetry plane. The Hough space symmetry plane is a plane corresponding to the symmetry planes determined by the methods discussed above.

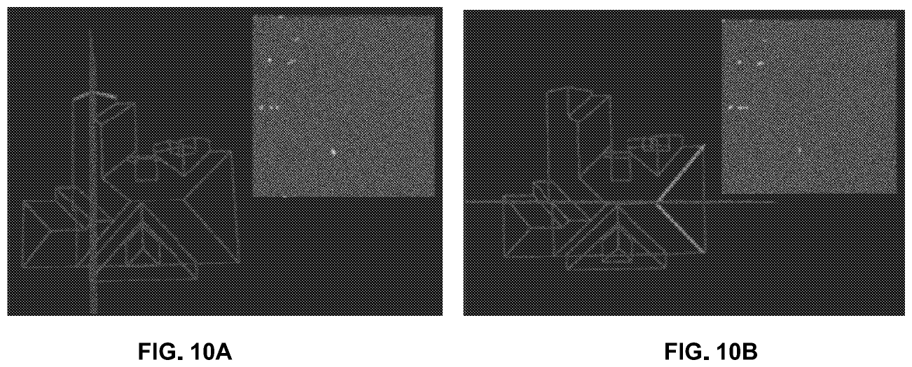

The Hough space symmetry plane is calculated for each of the selected cells using inverse calculations. In step 74, the system selects a rho value (ρ) and theta value (θ) of a cell. In step 76, the system determines a normal vector (n) for the Hough space symmetry plane using the formula: n=(cos θ, sin θ, 0). In step 78, the system determines a point (p) on the Hough space symmetry plane using the formula: p=r+p*n. In step 80, the system constructs the Hough space symmetry plane from the values of the point and the normal vector. This yields a set of Hough space symmetry planes. A relative relevance of each Hough space symmetry plane is given by the value accumulated in their respective cells. FIGS. 10A and 10B illustrate a diagram of the Hough space symmetry planes.

In should be understood that the resolution of the symmetry plane is related to the predetermined number of equal intervals within the range of the line parameter rho and the line parameter theta. For example, when the predetermined number of equal intervals is 60, the theta values are limited to multiples of six degrees. As such, when more resolution is desired, each symmetry plane can be refined by repeating the calculation procedure in a new Hough space where the cell in the original space is divided into subcells, (for example, 50-100) in each dimension.

A principal orientation(s) of a structure represented by 3D segment cloud can be obtained from a list of relevant symmetry planes (e.g., vertical symmetry planes). In an example, the system can calculate the principal orientation(s) by constructing a histogram of a symmetry plane orientations modulus at 90°. An angle given by the position of the largest peak and the same value +90° can be considered the main orientation(s).

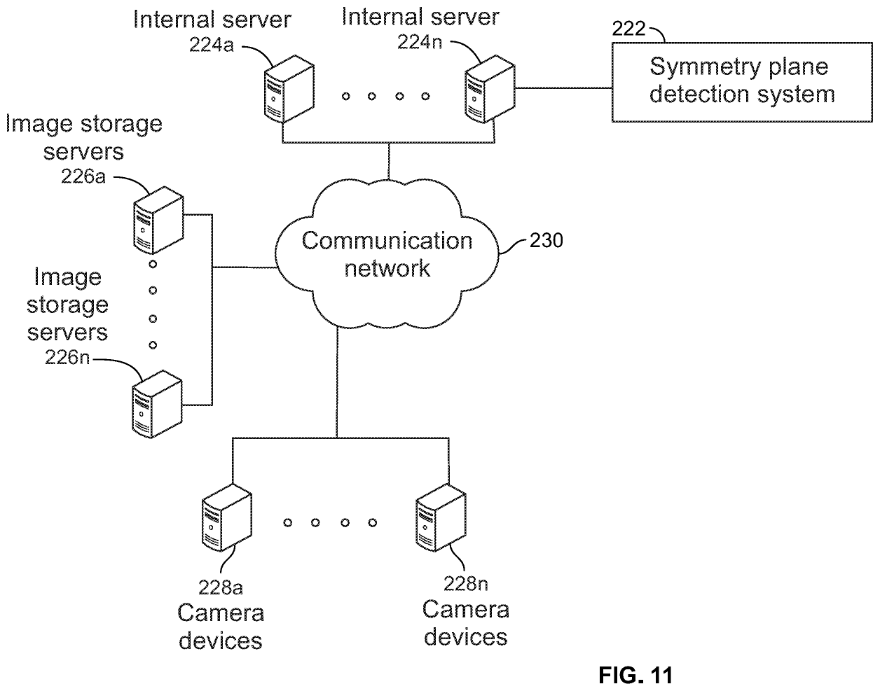

FIG. 11 is a diagram illustrating computer hardware and network components on which the system of the present disclosure could be implemented. The system can include a plurality of internal servers 224a-224n having at least one processor and memory for executing the computer instructions and methods described above (which could be embodied as computer software 222 illustrated in the diagram). The system can also include a plurality of image storage servers 226a-226n for receiving the image data and video data. The system can also include a plurality of camera devices 228a-228n for capturing image data and video data. These systems can communicate over a communication network 230. The symmetry plane detection system or engine can be stored on the internal servers 224a-224n or on an external server(s). Of course, the system of the present disclosure need not be implemented on multiple devices, and indeed, the system could be implemented on a single computer system (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for automatically modeling symmetry planes and principal orientations from three dimensional (“3D”) segments, comprising:
a processor in communication with an input source; and
computer system code executed by the processor, the computer system code causing the processor to:
receive a set of 3D segments representing a structure from the input source, wherein the set of 3D segments comprises one or more segment pairs;
generate symmetry plane data by calculating a symmetry plane for each of the one or more segment pairs;
accumulate the symmetry plane data in a Hough space; and
construct one or more Hough space symmetry planes from the symmetry plane data and calculate a principal orientation of the structure.

2. The system of claim 1, wherein the computer system code causes the processor to:
select a first segment pair from the one or more segment pairs;
determine whether the first segment pair is a parallel pair or a crossing pair; and
when the first segment pair is a parallel pair, project a first point from a first line segment of the first segment pair onto a second line segment of the first segment pair to obtain a second point, calculate a normal vector and a reference point, and construct a symmetry plane between the first line segment and the second line segment using the reference point and the normal vector.

3. The system of claim 2, wherein the computer system code causes the processor to:
determine whether the symmetry plane is vertical within a predetermined tolerance value and, when the symmetry plane is determined to be vertical within the predetermine tolerance value, generate an output comprising the first line segment, the second line segment, and the symmetry plane.

4. The system of claim 2, wherein when the first segment pair is a crossing pair, the computer system code causes the processor to:
determine a reference point by determining a crossing point of a first line comprising the first line segment and a second line comprising the second line segment;
calculate a first central point of the first line segment and a second central point of the second line segment;
calculate a first vector from the reference point to the first central point and a second vector from the reference point to the second central point;
normalize the first vector and the second vector; and
calculate a plane comprising the reference point, the first vector and the second vector.

5. The system of claim 4, wherein the computer system code causes the processor to:
determine whether the plane is vertical within a predetermined tolerance value and whether the first line segment and the second line segment are within a predetermined distance from each other; and
calculate a normal vector.

6. The system of claim 1, wherein the computer system code causes the processor to determine parameters of the symmetry plane data and accumulate symmetry planes in the Hough space.

7. The system of claim 1, wherein the Hough space is defined in two dimensions using a line parameter rho and a line parameter theta and wherein the Hough space comprises a plurality of cells.

8. The system of claim 7, wherein each cell of the plurality of cells comprises a real number accumulator associated with the line parameter rho and the line parameter theta.

9. The system of claim 8, wherein the computer system code causes the processor to:
select a number of cells from the plurality of cells with a highest accumulated number;
select a rho value and a theta value of each of the number of cells;
determine a normal vector for each of the one or more Hough space symmetry planes using the theta value;
determine a point on each of the one or more Hough space symmetry planes using at least the normal vector and the rho value; and
construct the one or more Hough space symmetry planes from the point and the normal vector.

10. The system of claim 1, wherein the computer system code causes the processor to construct a histogram of a symmetry plane orientations modulus at 90°.

11. A method for automatically modeling symmetry planes and principal orientations from three dimensional (“3D”) segments, comprising the steps of:
receiving a set of 3D segments representing a structure from the input source, wherein the set of 3D segments comprises one or more segment pairs;
generating symmetry plane data by calculating a symmetry plane for each of the one or more segment pairs;
accumulating the symmetry plane data in a Hough space; and
constructing one or more Hough space symmetry planes from the symmetry plane data and calculating a principal orientation of the structure.

12. The method of claim 11, wherein step of generating symmetry plane data comprises:
selecting a first segment pair from the one or more segment pairs;
determining whether the first segment pair is a parallel pair or a crossing pair; and
when the first segment pair is a parallel pair, projecting a first point from a first line segment of the first segment pair onto a second line segment of the first segment pair to obtain a second point, calculating a normal vector and a reference point, and constructing a symmetry plane between the first line segment and the second line segment using the reference point and the normal vector.

13. The method of claim 12, further comprising:
determining whether the symmetry plane is vertical within a predetermined tolerance value and, when the symmetry plane is determined to be vertical within the predetermine tolerance value, generating an output comprising the first line segment, the second line segment, and the symmetry plane.

14. The method of claim 12, further comprising:
determining a reference point by determining a crossing point of a first line comprising the first line segment and a second line comprising the second line segment;
calculating a first central point of the first line segment and a second central point of the second line segment;
calculating a first vector from the reference point to the first central point and a second vector from the reference point to the second central point;
normalizing the first vector and the second vector; and
calculating a plane comprising the reference point, the first vector and the second vector.

15. The method of claim 14, further comprising:
determining whether the plane is vertical within a predetermined tolerance value and whether the first line segment and the second line segment are within a predetermined distance from each other; and
calculating a normal vector.

16. The method of claim 11, wherein step of accumulating the symmetry plane data in a Hough space further comprises determining parameters of the symmetry plane data and accumulating symmetry planes in the Hough space.

17. The method of claim 11, wherein the Hough space is defined in two dimensions using a line parameter rho and a line parameter theta and wherein the Hough space comprises a plurality of cells.

18. The method of claim 17, wherein each cell of the plurality of cells comprises a real number accumulator that is associated with the line parameter rho and the line parameter theta.

19. The method of claim 18, wherein step of constructing one or more Hough space symmetry planes from the symmetry plane data further comprises:
selecting a number of cells from the plurality of cells with a highest accumulated number;
selecting a rho value and a theta value of each of the number of cells;
determining a normal vector for each of the one or more Hough space symmetry planes using the theta value;
determining a point on each of the one or more Hough space symmetry planes using at least the normal vector and the rho value; and
constructing the one or more Hough space symmetry planes from the point and the normal vector.

20. The method of claim 11, wherein step of calculating a principle orientation of the structure comprises constructing a histogram of a symmetry plane orientations modulus at 90°.
